(19) United States
(12) Patent Application Publication
(10) Pub. No.: US 2012/0256331 A1
(43) Pub. Date: Oct. 11, 2012

(54) COLUMN WITH CARRYING DEVICES FOR COLUMN INTERNALS

(75) Inventors: Dieter Mihailowitsch, Geretsried (DE); Jochen Honicke, Pirna (DE)

(73) Assignee: Linde Aktiengesellschaft, Munchen (DE)

(21) Appl. No.: 13/508,813

(22) PCT Filed: Nov. 4, 2010
(86) PCT No.: PCT/EP2010/006732

§ 371 Date: Jun. 19, 2012

(30) Foreign Application Priority Data
Nov. 10, 2009 (DE) 10 2009 052 650.1

(51) Int. Cl. B01D 3/32

(52) U.S. Cl. 261/114.1

(57) ABSTRACT

The invention relates to a column (1) with carrying devices for column internals, the carrying devices having load introducing elements, for example formed as peripheral carrying rings (3) or carrying brackets, which are fastened to the inner wall of the column, and transverse carriers (4), which are supported from below by the load introducing elements and are intended for carrying the column internals. In order to minimize the size of the transverse carriers (4), vertical supporting carriers (5), which support the transverse carriers (4), are provided inside the column (1).

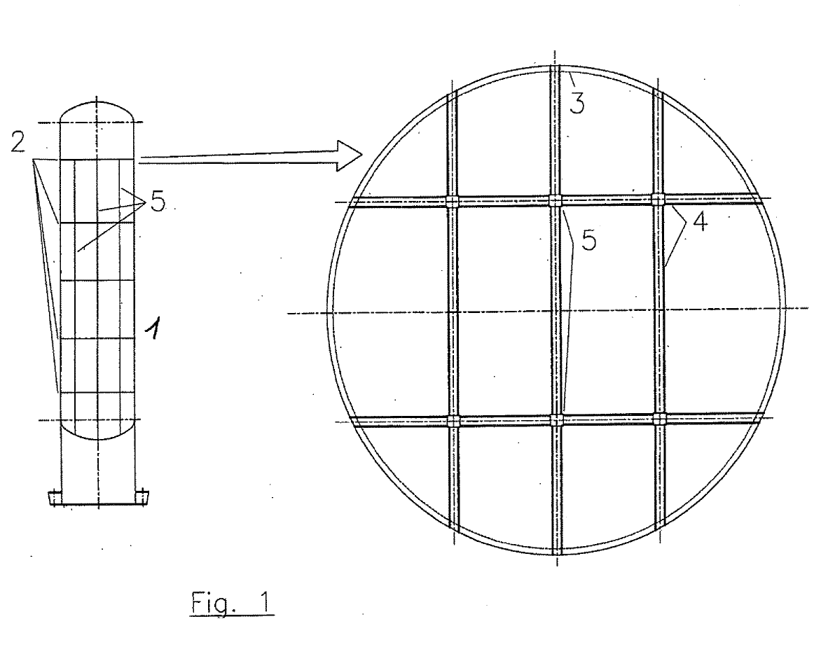

The invention relates to a column with carrying devices for column internals, the carrying devices having load introducing elements, which are fastened to the inner wall of the column and are intended for introducing load forces into the column wall, and transverse carriers, which are supported from below by the load introducing elements and are intended for carrying the column internals.

Columns are used for a wide variety of mass transfer processes in the chemical engineering treatment of fluids, such as for example rectification, absorption, adsorption, extraction or washing processes. In order to bring the fluids flowing in counter-current or co-current into contact with one another, i.e. in particular to increase the surface area of contact, randoms packings, structured packings or trays—referred to in a generalized sense as column internals—are used. These column internals must be mechanically held. This is accomplished by load introducing elements, which are generally formed as carrying rings running around the inner wall of the column, and by transverse carriers, which make it possible for the column internals that are used to remain stably in their position, in particular even under the influence of liquids building up and forces of flow. Furthermore, in order not to put the chemical engineering function at risk, bending of this supporting structure must be limited.

The transverse carriers are usually horizontally aligned and in practice simply rest on the load introducing elements. They are required to ensure the mechanical stability of the column internals. However, they hinder the uniform distribution of the fluids. Their size is determined by the load of the column internals, the permissible bending and the diameter of the column. The greater the load and the greater the diameter, the larger the horizontal bearing carriers must be. Associated with this, the chemical engineering function of the column is impaired by the aforementioned hindrance of the distribution of the fluids. Furthermore, the loads absorbed by means of the horizontal bearing carriers should be diverted away by means of the column wall, which may lead to an increase in the required column wall thickness.

The object of the present invention is therefore to provide a column of the generic type with which it is possible to reduce the size of the transverse carriers while retaining the required stability of the supporting structure.

The stated object is achieved according to the invention by vertical supporting carriers, which support the transverse carriers, being provided inside the column.

The invention is based on the idea that the size of the transverse carriers can be minimized if vertical supporting carriers are used inside the column in addition to the load introducing elements. As a result, the loads of the column internals do not have to be diverted away exclusively by means of the column wall.

The load introducing elements may in this case be formed for example as peripheral carrying rings, which are fastened to the inner wall of the column and so are supported on the entire circular circumference of the inner wall of the column. Another possibility is to form the load introducing elements as local carrying brackets, which are only fastened to the inner wall of the column in the region of the transverse carriers.

Supporting brackets which support the transverse carriers are expediently provided in the upper region of the vertical supporting carriers. In the simplest case, the transverse carriers are horizontally aligned and rest on the supporting brackets. The transverse carriers may, however, also have a more complicated geometrical form and an alignment deviating from the horizontal. Furthermore, instead of simply resting on the supporting brackets, the transverse carriers may also be supported by the supporting brackets by some other retaining structure, for example by being made to engage or being screwed. The length to be spanned can be minimized by the use of the supporting brackets, and consequently the size of the transverse carriers can be reduced considerably.

A development of the invention provides that the vertical supporting carriers consist of a high-strength material. This allows the chemical engineering function of the column to be further improved, and consequently the cross section of the transverse carriers to be further reduced. In addition or alternatively, the load introducing elements and/or the transverse carriers may also consist of a high-strength material.

According to an advantageous refinement of the invention, the outer vertical supporting carriers are at a distance from the inner wall of the column of about 4 to about 5 m. Furthermore, the vertical supporting carriers are preferably at a distance from one another of about 4 to about 10 m, particularly preferably of about 4 to about 8 m.

A series of advantages are obtained with the invention: use of the vertical supporting carriers minimizes the size of the transverse carriers, which on the one hand leads to less disturbance of the distribution of the fluids, and consequently improvement in the chemical engineering function of the column. On the other hand, these carriers are also less costly. Furthermore, the forces that are removed by means of the column wall are reduced.

The invention is to be explained in more detail below on the basis of an exemplary embodiment schematically represented in the FIGURE.

The FIGURE shows a column with carrying devices for column internals in longitudinal section (left side of the FIGURE) and a detailed view of a cross section through a carrying plane of the column (right side of the FIGURE).

The column 1 has carrying planes 2, at the height of which in each case a load introducing element, formed in this example as a carrying ring 3, is fastened to the inner wall of the column. Horizontal bearing carriers 4 rest on the carrying rings 3. To allow the load on the carrying rings 3 to be relieved and the size of the horizontal bearing carriers 4 to be reduced, vertical supporting carriers 5 are additionally provided inside the column 1. In this case, the outer vertical supporting carriers 5 are at a distance from the inner wall of the column of 5 m. The distance of the vertical supporting carriers 5 from one another is 8 m.

1. Column with carrying devices for column internals, the carrying devices having load introducing elements, which are fastened to the inner wall of the column and are intended for introducing load forces into the column wall, and transverse carriers, which are supported from below by the load introducing elements and are intended for carrying the column internals, characterized in that vertical supporting carriers (5), which support the transverse carriers (4), are provided inside the column (1).

2. Column according to claim 1, characterized in that supporting brackets, which support the transverse carriers (4), are provided in the upper region of the vertical supporting carriers (5).

3. Column according to claim 1, characterized in that the vertical supporting carriers (5) consist of a high-strength material.

4. Column according to claim 1, characterized in that the load introducing elements (3) and/or the transverse carriers (4) consist of a high-strength material.

5. Column according to claim 1, characterized in that the outer vertical supporting carriers (5) are at a distance from the inner wall of the column of about 4 to about 5 m.

6. Column according to claim 1, characterized in that the vertical supporting carriers (5) are at a distance from one another of about 4 to about 10 m, preferably about 4 to about 8 m.
